(19) United States
(12) Patent Application Publication
(10) Pub. No.: US 2013/0149437 A1
(43) Pub. Date: Jun. 13, 2013

(54) METHOD FOR MANUFACTURING PRINTED CIRCUIT BOARD

(71) Applicants: Kyung Seob Oh, Gyunggi-do (KR); Young Do Kweon, Seoul (KR); Jin Gu Kim, Gyunggi-do (KR); Hyung Jin Jeon, Gyunggi-do (KR)

(72) Inventors: Kyung Seob Oh, Gyunggi-do (KR); Young Do Kweon, Seoul (KR); Jin Gu Kim, Gyunggi-do (KR); Hyung Jin Jeon, Gyunggi-do (KR)

(73) Assignee: SAMSUNG ELECTRO-MECHANICS CO., LTD., Gyunggi-do (KR)

(21) Appl. No.: 13/401,881

(22) Filed: Feb. 22, 2012

(30) Foreign Application Priority Data
Dec. 13, 2011 (KR) 1020110133823

(51) Int. Cl. B05D 5/12; B05D 3/00; C25D 5/34

(52) U.S. Cl. 427/97.2; 427/97.8; 205/205; 427/97.9

(57) ABSTRACT

Disclosed herein is a method for manufacturing a printed circuit board.

According to a preferred embodiment of the present invention, there is provided a method for manufacturing a printed circuit board, including: preparing a base substrate; forming a carrier layer on the base substrate; forming a through via hole penetrating the carrier layer and the base substrate; forming a plating layer on the carrier layer and an inner wall of the through via hole; filling the through via hole with a conductive paste; removing a portion of the plating layer formed on the carrier layer; removing the carrier layer; and forming a circuit layer on the base substrate.

### CROSS REFERENCE TO RELATED APPLICATION

This application claims the benefit of Korean Patent Application No. 10-2011-0133823, filed on Dec. 13, 2011, entitled “Method of Manufacturing Printed Circuit Board”, which is hereby incorporated by reference in its entirety into this application.

### BACKGROUND OF THE INVENTION

1. Technical Field

The present invention relates to a method for manufacturing a printed circuit board.

2. Description of the Related Art

Recently, the trend for multifunctional and high-speed electronic products has progressed at a rapid speed. In accordance with this trend, a semiconductor chip and a semiconductor chip-mounted printed circuit board connecting a semiconductor chip and a substrate have also been developed at a very high speed.

The demands for developing the semiconductor chip-mounted printed circuit board are closely related in terms of high speed and high integration of the semiconductor chip-mounted printed circuit board. In order to satisfy these demands, it is necessary to improve and develop the semiconductor chip-mounted printed circuit board, such as smallness and lightness, fine circuits, excellent electric properties, high reliability, a high-speed signal transfer structure, and the like.

In forming the fine circuits, flatness of the printed circuit board is important. For example, the surface roughness of the base material itself of a printed circuit board having fine circuits may cause poor flatness of a buildup layer to be formed on the base material. Since circuit layers of the buildup layer are also formed on a surface having poor flatness, it is difficult to realize fine circuits.

Therefore, a method for planarizing the printed circuit board in order to realize fine circuits was proposed. (Korean Patent No. 10-0797720)

### SUMMARY OF THE INVENTION

The present invention has been made in an effort to provide a method for manufacturing a printed circuit board capable of improving flatness of a circuit layer.

Further the present invention has been made in an effort to provide a method for manufacturing a printed circuit board capable of forming fine circuit patterns.

Further, the present invention has been made in an effort to provide a method for manufacturing a printed circuit board capable of reducing the thickness of the printed circuit board.

According to a preferred embodiment of the present invention, there is provided a method for manufacturing a printed circuit board, including: preparing a base substrate; forming a carrier layer on the base substrate; forming a through via hole penetrating the carrier layer and the base substrate; forming a plating layer on the carrier layer and an inner wall of the through via hole; filling the through via hole with a conductive paste; removing a portion of the plating layer formed on the carrier layer; removing the carrier layer; and forming a circuit layer on the base substrate.

The carrier layer may be an attachable and detachable film formed on the base substrate.

The carrier layer may be a copper foil.

The plating layer may be formed by an electroless plating method or an electroplating method.

In the forming of the plating layer, the plating layer may be formed of copper.

The method may further include forming an insulating layer on the circuit layer, after the forming of the circuit layer.

The method may further include forming a solder resist layer on the circuit layer, after the forming of the circuit layer.

The method may further include polishing a surface of the base substrate, after the removing of the carrier layer.

### BRIEF DESCRIPTION OF THE DRAWINGS

FIGS. 1 to 6 show a method for manufacturing a printed circuit board according to the prior art; and

FIGS. 7 to 17 show a method for manufacturing a printed circuit board according to a preferred embodiment of the present invention.

### DESCRIPTION OF THE PREFERRED EMBODIMENTS

Various objects, advantages and features of the present invention will become apparent from the following description of preferred embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description and preferred embodiments taken in conjunction with the accompanying drawings. In the specification, in adding reference numerals to components throughout the drawings, it is to be noted that like reference numerals designate like components even though components are shown in different drawings.

Further, when it is determined that the detailed description of the known art related to the present invention may obscure the gist of the present invention, the detailed description thereof will be omitted. Terms used in the specification, ‘first’, ‘second’, etc., can be used to describe various components, but the components are not to be construed as being limited to the terms.

Hereinafter, a method for manufacturing a printed circuit board according to a preferred embodiment of the present invention will be described with reference to the accompanying drawings.

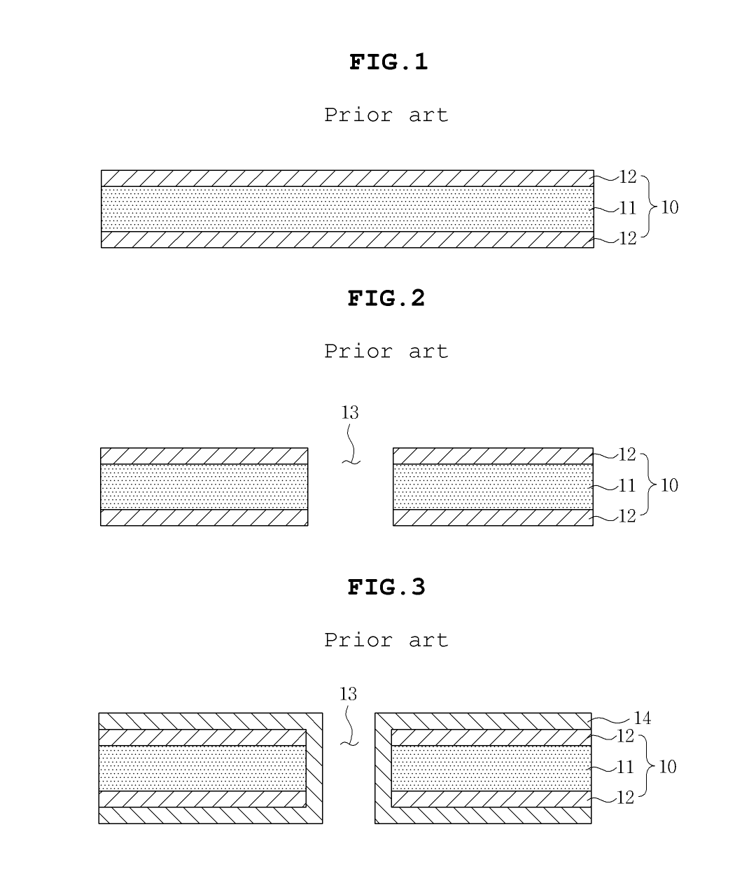

FIGS. 1 to 6 show a method for manufacturing a printed circuit board according to the prior art.

Referring to FIG. 1, a base substrate 10 is provided.

The base substrate 10 may be, but not particularly limited to, a copper clad layer (CCL) formed by an insulating material 11 and a copper foil layer 12 laminated on both surfaces of the insulating material 11, as shown in FIG. 1.

Referring to FIG. 2, a through via hole 13 is formed.

The through via hole 13 is a hole penetrating the base substrate 10. The through via hole 13 may be formed by a mechanical drill using a cutting blade and a laser drill using laser.

Referring to FIG. 3, a plating layer 14 may be formed.

The plating layer 14 may be formed on an inner wall of the through via hole 13 and on the base substrate 10. The plating layer 14 may be formed by an electroless plating method or an electroplating method. The plating layer 14 may be formed of a conductive metal material.

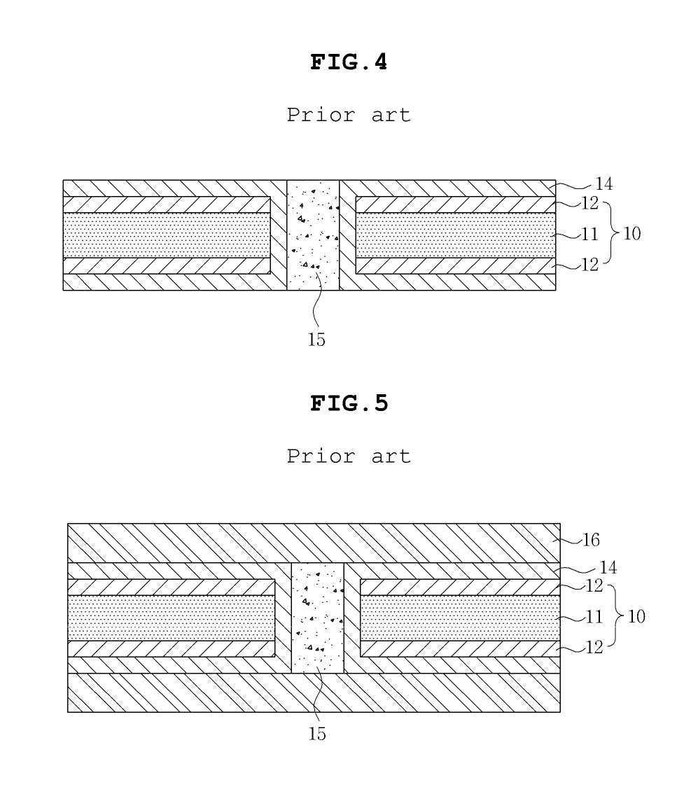

Referring to FIG. 4, a through via 15 is formed.

The through via 15 may be formed by filling a filler the through via hole 13.

The filler filling the through via hole 13 may be a plugging ink, which is an insulating material paste. Here, if the filler protrudes out of the through via hole 13, a protruding portion of the filler, which protrudes out of the plating layer 14 may be removed. For example, a polishing process using a polishing brush or buffer may be performed on the protruding portion of the filler, which protrudes out of the plating layer 14.

Referring to FIG. 5, a circuit layer 16 may be formed on the through via 15 and the plating layer 14. The circuit layer 16 may be formed by a conventional plating method.

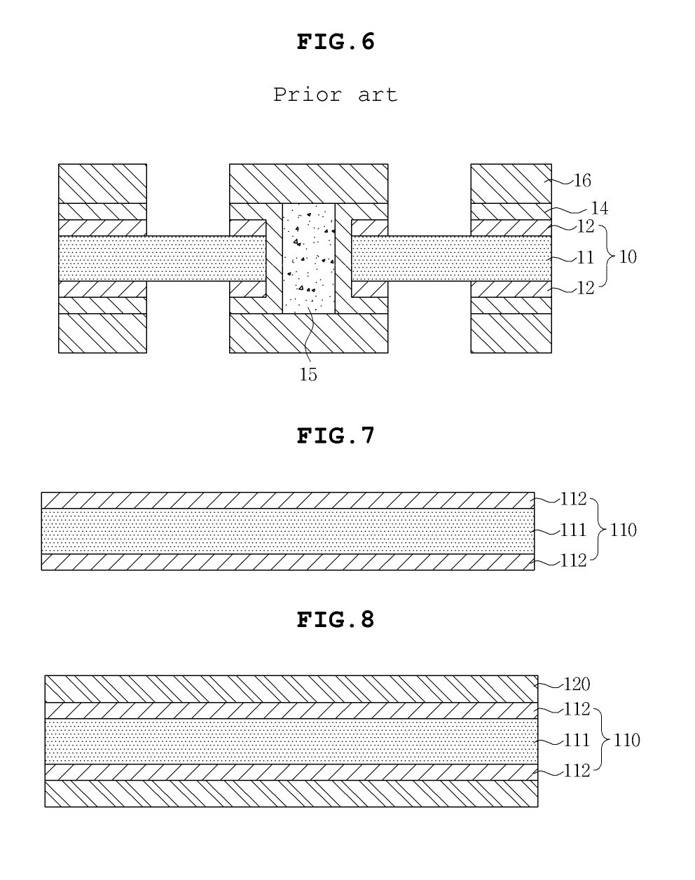

Referring to FIG. 6, a patterning process is performed on the circuit layer 16 to form a circuit pattern. The circuit layer 16, the plating layer 14, and the copper foil layer 12 may be patterned by etching, thereby forming the circuit pattern as shown in FIG. 6. Here, a conventional etching method used at the time of forming the circuit pattern may be employed.

FIGS. 7 to 17 show a method for manufacturing a printed circuit board according to a preferred embodiment of the present invention.

Referring to FIG. 7, a base substrate 110 is provided.

The base substrate 110 may be, but not particularly limited to, a copper clad layer (CCL) may be formed by an insulating material 111 and a copper foil layer 112 laminated on both surfaces of the insulating material 111, as shown in FIG. 7.

Referring to FIG. 8, a carrier layer 120 is formed on the base substrate 110.

The carrier layer 120 may be formed on both surfaces of the base substrate 110.

The carrier layer 120 may be formed in order to secure flatness of a circuit layer 150, which will be formed on the base substrate 110 later. The carrier layer 120 according to a preferred embodiment of the present invention may have a flat surface having low roughness. The copper foil layer 112 of the base substrate 110 is formed on the insulating material 111. Therefore, the surface of the copper foil layer 112, which is formed on the insulating material 111, also has high roughness due to high roughness of the insulating material 111. However, the carrier layer 120 is a copper foil layer, and formed without an insulating material, that is, a core layer. Therefore, the carrier layer 120 has lower roughness than the copper foil layer 112, and thereby to have better flatness than the copper foil to layer 112.

The carrier layer 120 may be formed on the base substrate 110 in an attachable and detachable film type. In addition, the carrier layer 120 may be formed of a metal. For example, the carrier layer 120 may be formed of a copper foil. This carrier layer 120 may be attached on the base substrate 110 by an adhesive material. The adhesive material may be a general adhesive material such as an epoxy resin. However, the forming method of the carrier layer 120 is not limited thereto. For example, the carrier layer 120 may be formed on the base substrate 110 by a method such as spraying, sputtering, or the like. As such, the forming method of the carrier layer 120 may be easily changed by those skilled in the art.

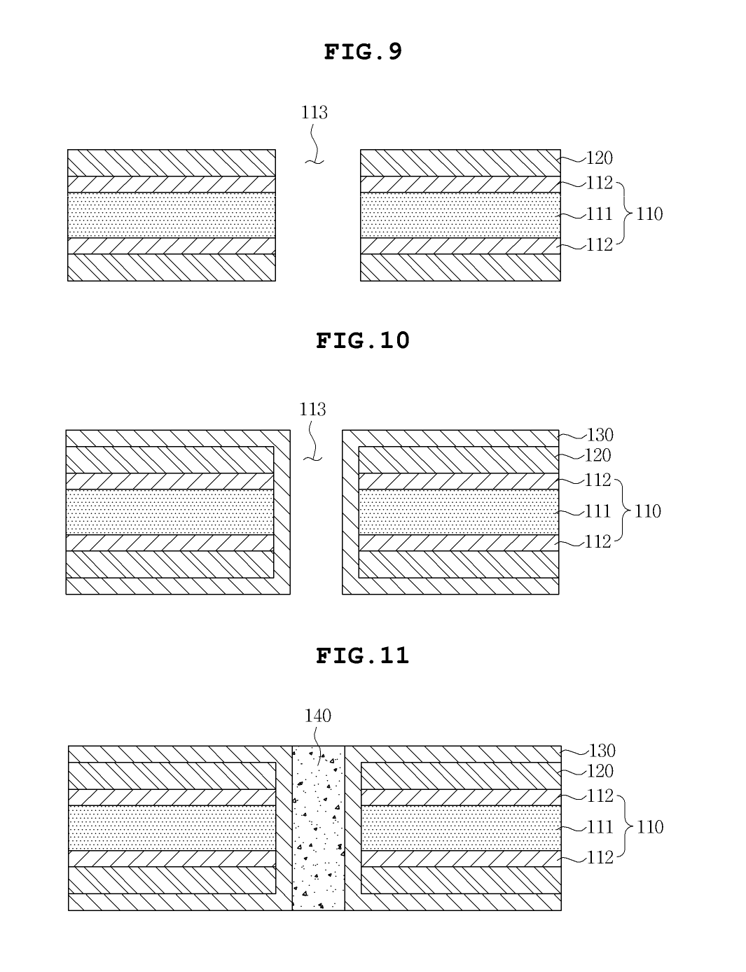

Referring to FIG. 9, a through via hole 113 is formed.

The through via hole 113 is a hole penetrating all of the base substrate 110 and the carrier layers 120 formed on both surfaces of the base substrate 110. The through via hole 113 may be formed by a mechanical drill using a cutting blade and a laser drill using laser. In the preferred example of the present invention, the through via hole 113 may be formed by using a CNC drill.

Referring to FIG. 10, a plating layer 130 may be formed.

The plating layer 130 may be formed on an inner wall of the through via hole 113 and on the carrier layers 120. The plating layer 130 may be formed by employing at least one of an electroless plating method and an electroplating method. Also, the plating layer 130 may be formed of a conductive metal material. According to the preferred embodiment of the present invention, the plating layer 130 may be formed of copper.

Referring to FIG. 11, the through via hole 113 may be filled with a filler 140.

The filler 140 filling the through via hole 113 may be a plugging ink, which is an insulating material paste. However, the kind of the filler 140 is not limited to the plugging ink. In other words, the filler 140 may be a conductive paste containing a conductive metal powder.

In a process of filling the through via hole 113 with the filler 140, if the filler 140 protrudes out of the through via hole 113, a protruding portion of the filler 140, which protrudes out of the plating layer 130, may be removed. For example, a polishing process using a polishing brush or buffer is performed on the protruding portion of the filler 140, which protrudes out of the plating layer 130.

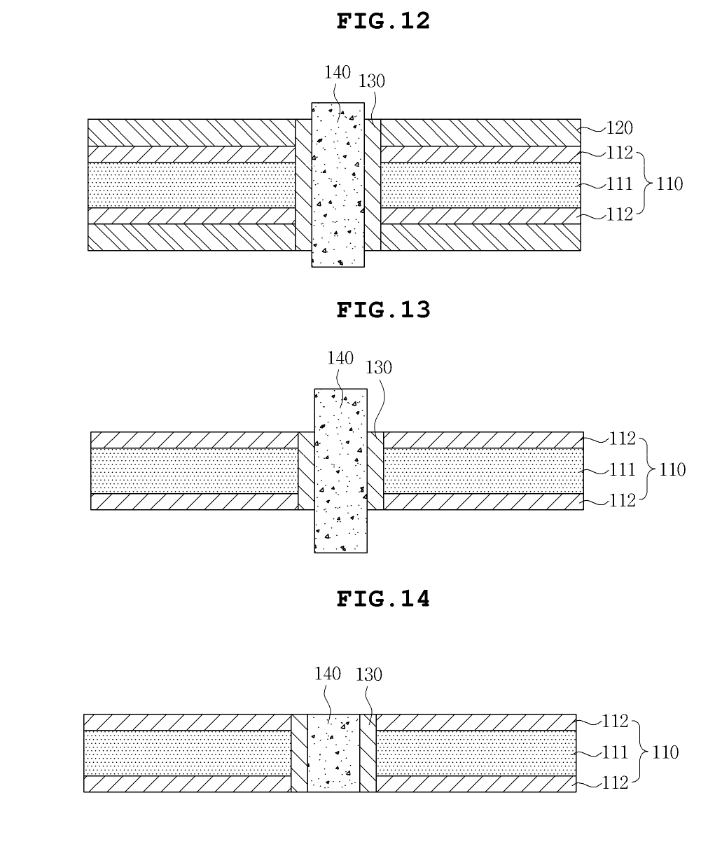

Referring to FIG. 12, the plating layer 130 may be partially removed.

The plating layer 130 may be conventionally removed by a chemical or physical etching method. The plating layer 130 may be removed by coating a chemical etching material or by using laser. Alternatively, the plating layer 130 may be removed by a polishing process. For example, the plating layer 130 may be removed at the same time when the protruding portion of the filler 140 is removed by the polishing process. The method for etching the plating layer is not limited thereto, and any one of the conventional methods for etching the plating layer 130 may be employed.

Referring to FIG. 13, the carrier layer 120 may be removed.

The carrier layer 120 may be removed by various methods depending on the materials used. For example, in a case where the carrier layer 120 is attached on the base substrate 110 in a film type by an adhesive material, the film type of carrier layer may be peeled out and removed. For example, the carrier layer 120 may be peeled out from the base substrate 110 by hands, tweezers, or the like. Alternatively, the carrier layer 120 may be removed by a conventional etching process.

Referring to FIG. 14, a surface of the base substrate 110 may be polished.

When the plating layer 130 and the carrier layer 120 are removed while the through via hole 113 is filled with the filler 140, a portion of the filler 140 may protrude out of the base substrate 110. Also, when the carrier layer 120 is removed, a residual material of the carrier layer 120 may remain on the surface of the base substrate 110. Therefore, the protruding portion of the filler 140 and the residual material of the carrier layer 120 remaining on the surface of the base substrate 110 may be removed by polishing the surface of the base substrate 110. In the present preferred embodiment of the present invention, the protruding portion of the filler 140 and the surface of the base substrate 110 are polished at the same time, but the polishing process of the surface of the base substrate 110 may be omitted.

Referring to FIG. 15, a circuit layer 150 may be formed. The circuit layer 150 may be formed on the copper foil layer 112 of the base substrate 110. The circuit layer 150 may be formed by a conventional plating method. The circuit layer 150 may be formed of a conductive metal. In the present preferred embodiment of the present invention, the circuit layer 150 may be formed of copper.

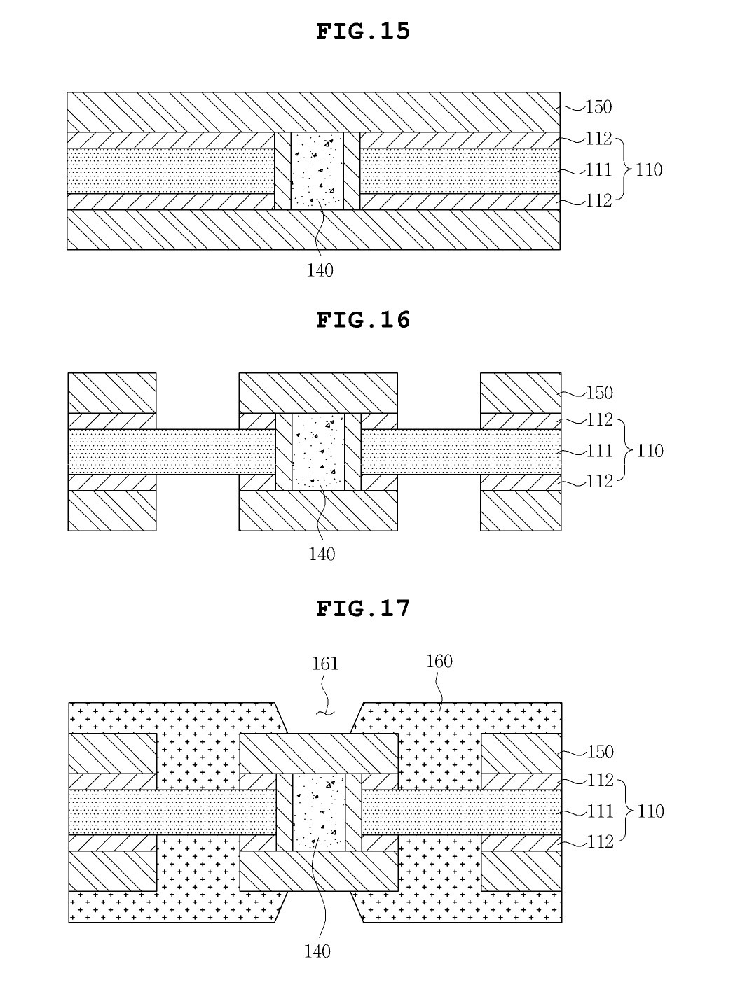

Referring to FIG. 16, a circuit pattern may be formed in the circuit layer 150. The circuit pattern of the circuit layer 150 may be formed by a conventional circuit pattern forming method. For example, a patterned etching resist (not shown) may be formed on the circuit layer 150. Etching may be performed on a portion of the circuit layer 150, which is exposed by the patterned etching resist (not shown). A conventional etching method used at the time of forming the circuit pattern may be employed. At the time of etching, the circuit layer 150 as well as the copper foil layer 112 underlying the circuit layer 150 may be etched at the same time. As such, after etching the circuit layer 150 and the copper foil layer 112, the etching resist (not shown) may be removed, thereby forming a circuit pattern in the circuit layer 150.

As such, according to the method for manufacturing a printed circuit board, the circuit layer 150 may be formed on the surface of the base substrate 110. In the prior art, the circuit layer is formed on the plating layer, after the plating layer is formed on the base substrate. However, in the prior art, when the plating layer is formed on the base substrate having high surface roughness, the plating layer to may be formed to have a higher surface roughness than the base substrate due to plating deviation. Then, the circuit layer formed on the plating layer has surface roughness higher than the surface roughness of the plating layer, and resultantly, the surface roughness of the circuit layer becomes very increased. However, according to the method for manufacturing a printed circuit board of the present preferred embodiment, since the circuit layer 150 is formed on the base substrate 110 from which the plating layer 130 is removed, the circuit layer 150 may have lower surface roughness and lower thickness as compared with the prior art.

Referring to FIG. 17, an insulating layer 160 may be formed on the circuit layer 150.

An insulating layer 160 may be formed on the circuit layer 150 in order to laminate an additional circuit layer. The insulating layer 160 may be formed of a conventional epoxy resin based material or a fluorine resin based material. A blind via hole 161 may be formed in the insulating layer 160 for interlayer electrical conduction. The blind via hole 161 may be formed by a mechanical drill or a laser drill. In a preferred embodiment of the present invention, the blind via hole 161 may be formed by using YAG laser or CO₂ laser. After that, the additional circuit layer may be stacked by a conventional circuit forming process.

If the circuit layer 150 is a circuit layer formed at the outermost portion of the printed circuit board, a solder resist layer, for protecting the circuit layer 150 from the outside, may be formed on the circuit layer 150. In addition, an opening portion, in which a bump for performing mounting and connecting external device is to be formed, may be formed in the solder resist layer. Here, the opening portion formed in the solder resist layer may be formed by the mechanical drill or laser drill.

According to the method for manufacturing a printed circuit board of the preferred embodiment of the present invention, flatness of the plating layer and the like formed on the carrier layer can be secured by forming the planarized carrier layer on the base substrate having high surface roughness. In addition, according to the method for manufacturing a printed circuit board of the preferred embodiments of the present invention, the circuit layer is formed on the base substrate after the plating layer and the carrier layer are removed, thereby reducing the surface roughness and the thickness of the circuit layer as compared with the prior art where the circuit layer is formed on the plating layer on the base substrate. Therefore, according to the method for manufacturing a printed circuit board of the preferred embodiments of the present invention, fine patterns can be formed to have lower surface roughness and lower thickness as compared with a case where the circuit layer is formed on the plating layer. In addition, the circuit layer is formed after the plating layer is removed on the base substrate by the method as above, thereby reducing thickness of the printed circuit board.

The method for manufacturing a printed circuit board according to the preferred embodiments of the present invention has been described by giving, as an example, a case where the circuit layer is formed on both surfaces of the base substrate, but it is obvious to those skilled in the art that the present invention can be applied to a case where the circuit layer is formed on one surface of the base substrate.

According to the method for manufacturing a printed circuit board of the preferred embodiment of the present invention, the flatness of the circuit layer formed on the base substrate can be improved, by forming the carrier layer having a flat surface on the base substrate.

According to the method for manufacturing a printed circuit board of the preferred embodiment of the present invention, the entire thickness of the circuit layer can be reduced, by etching the plating layer formed on the base substrate and then forming the circuit layer.

According to the method for manufacturing a printed circuit board of the preferred embodiment of the present invention, fine circuit patterns can be realized due to improvement in the to flatness of the circuit layer.

According to the method for manufacturing a printed circuit board of the preferred embodiment of the present invention, the thickness of the printed circuit board can be reduced.

Although the preferred embodiments of the present invention have been disclosed for illustrative purposes, they are for specifically explaining the present invention and thus a method for manufacturing a printed circuit board according to the present invention is not limited thereto, and those skilled in the art will appreciate that various modifications, additions and substitutions are possible, without departing from the scope and spirit of the invention as disclosed in the accompanying claims.

Accordingly, any and all modifications, variations, or equivalent arrangements should be considered to be within the scope of the invention, and the detailed scope of the invention will be disclosed by the accompanying claims.

What is claimed is:

1. A method for manufacturing a printed circuit board, comprising:
preparing a base substrate;
forming a carrier layer on the base substrate;
forming a through via hole penetrating the carrier layer and the base substrate;
forming a plating layer on the carrier layer and an inner wall of the through via hole;
filling the through via hole with a conductive paste;
removing a portion of the plating layer formed on the carrier layer;
removing the carrier layer; and
forming a circuit layer on the base substrate.

2. The method as set forth in claim 1, wherein the carrier layer is an attachable and detachable film formed on the base substrate.

3. The method as set forth in claim 1, wherein the carrier layer is a copper foil.

4. The method as set forth in claim 1, wherein the plating layer is formed by an electroless plating method or an electroplating method.

5. The method as set forth in claim 1, wherein in the forming of the plating layer, the plating layer is formed of copper.

6. The method as set forth in claim 1, further comprising forming an insulating layer on the circuit layer, after the forming of the circuit layer.

7. The method as set forth in claim 1, further comprising forming a solder resist layer on the circuit layer, after the forming of the circuit layer.

8. The method as set forth in claim 1, further comprising polishing a surface of the base substrate, after the removing of the carrier layer.
